(19) United States
(12) Patent Application Publication
(10) Pub. No.: US 2008/0075136 A1
(43) Pub. Date: Mar. 27, 2008

(54) System and method for the improvement of optical transmission efficiency in laser systems

(76) Inventor: Vincent Vazquez, Winter Springs, FL (US)

Correspondence Address: ALCON, IP LEGAL, TB4-8, 6201 SOUTH FREEWAY, FORT WORTH, TX, 76134, US

(21) Appl. No.: 11/526,786

(22) Filed: Sep. 25, 2006

(51) Int. Cl. H01S 3/08

(52) U.S. Cl. 372/92

(57) ABSTRACT

Embodiments of the present invention provide a system and method for improving the optical transmission efficiency of laser systems and increasing the lifetime of laser system components. An embodiment of the present invention can include creating spent excimer laser gas in a laser cavity and directing the spent excimer laser gas to a volume at least partially in the optical path of a laser beam.

### TECHNICAL FIELD OF THE INVENTION

The present invention related to laser systems. More particularly, embodiments of the present invention relate to increasing the efficiency of a laser. Even more particularly, embodiments of the present invention relate to systems and methods for filling volumes in a n optical path of a laser beam with spent laser gas to displace Oxygen and prevent the formation of Ozone.

### BACKGROUND

Ozone (O3) obstructs the transmission of ultraviolet (UV) light. Because Ozone obstructs the transmission of UV light, laser beams comprised of UV light are attenuated if Ozone gas is present in the beam path. Ozone can be formed through the excitation of Oxygen molecules caused by the interaction of Oxygen with the laser beam. Thus a laser can produce the very Ozone that attenuates beam power.

To overcome Ozone attenuation, a laser must be operated at higher powers to compensate for the energy losses due to attenuation. Operating the laser at higher powers results in the initial laser optics-including the output coupler and the telescope optics-being subjected to higher energy densities. This exposure reduces the life of the affected optics. Furthermore, components of a laser operating at a higher energy output will typically have a shorter lifetime than if the laser were able to operate at lower power. For example, the gas used to produce a laser beam in an excimer laser will typically degrade faster when the laser is operated at higher power levels.

Laser systems attempt to overcome the formation of Ozone by purging volumes in the optical path of the laser with nitrogen or forcing air through volumes in the optical path to expel Ozone created by the operation of the laser. Purging volumes in the optical path with Nitrogen requires either that the volumes be sealed to prevent the loss of Nitrogen and the possible influx of Oxygen or that the laser system include an apparatus for the flushing of Nitrogen through volumes in the optical path. Both of these methods raise the cost of the system and can increase the size and maintenance of the laser system. Using air to expel Ozone increases the size and maintenance of the laser system for similar reasons. Furthermore, air purging does not eliminate the future buildup of Ozone because the laser beam will cause the formation of Ozone by interacting with Oxygen molecules in the air. Therefore, there is a need for a system and method which reduces or prevents Ozone formation in the optical path of the laser beam.

### SUMMARY OF THE INVENTION

Embodiments of the present invention provide a system and method for improving the optical transmission efficiency of a laser system that are substantially more convenient and efficient than prior art systems and methods for improving transmission efficiency. One embodiment of the present invention includes a method for improving transmission efficiency. The method can comprise the steps of creating spent excimer laser gas in a laser cavity and directing the spent excimer laser gas to a volume at least partially in an optical path of a laser beam.

Another embodiment of the current invention can include a laser system comprising a laser configured to produce a laser beam, the laser comprising a laser cavity configured to contain a laser gas, the laser system defining a first volume at least partially in the optical path of the laser beam and one or more valves fluidly coupled to the first volume and the laser cavity to selectively couple the laser cavity to the first volume.

Yet another embodiment of the invention includes a method comprising directing laser gas from a laser cavity of a laser system to a first volume at least partially in the optical path of a laser beam produced by the laser system and sealing the laser gas in the first volume until a subsequent laser gas change.

Embodiments of the present invention provide the advantage that the optical transmission efficiency of a laser system is improved. Embodiments of the present invention provide additional advantages in that this method of improving transmission efficiency is less cumbersome and more efficient than prior art systems. Furthermore, because optical transmission efficiency is improved, the laser can be operated at lower power, increasing the lifetime of laser system components.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of an embodiment of a laser system according to this invention;

FIG. 2 is a diagrammatic representation of components of one embodiment of a laser system according to this invention which uses spent laser gas to prevent Ozone attenuation;

FIG. 3 is a block diagram of an embodiment of a system of this invention for using spent laser gas to prevent Ozone attenuation; and

FIG. 4 is a graph of a gas mixture ratio in a closed volume in an embodiment of a laser system according to this invention which uses spent laser gas to prevent Ozone attenuation.

### DETAILED DESCRIPTION

Preferred embodiments of the invention are illustrated in the FIGURES, like numerals being used to refer to like and corresponding parts of the various drawings.

Embodiments of the present invention use spent excimer laser gas to purge and fill volumes in a laser beam path. More specifically, in an excimer laser system, spent excimer laser gas is used to purge and displace gases in the laser beam path, thus purging and preventing the formation of Ozone. Spent excimer laser gas can be a gas having a very high percentage (greater than 95%) of Neon. Spent laser gas can be directed into sealed volumes in the laser beam path, thus displacing air and Ozone. Because Ozone and Oxygen have been replaced by spent laser gas, in the sealed volumes, there is no Ozone to attenuate the laser beam and there is no Oxygen to form new Ozone. Because attenuation is less, the laser can be operated at lower power, thus increasing the lifetime of laser system components.

One embodiment of the present invention works as follows: In an excimer laser system, spent excimer gas having a high percentage of pure Neon is filtered to remove residual Fluorine and other contaminants. This filtered spent laser gas is used to purge and fill a sealed optical laser beam shaping module assembly (BSM), thus displacing air and Ozone. Because there is little or no Oxygen in the filtered laser gas, when the laser beam passes through the gas, little or no Ozone is formed. Consequently, beam attenuation is diminished. Thus, laser beam attenuation in the BSM is minimized. Other sealed volumes in the laser beam path can similarly be purged of air and Ozone by displacing the air and Ozone with filtered spent laser gas. In empirical testing, this system allowed an Alcon L6000 refractive surgical laser modified according to the present invention to be fired 10,000,000 times without measurable damage to the optical components of the BSM.

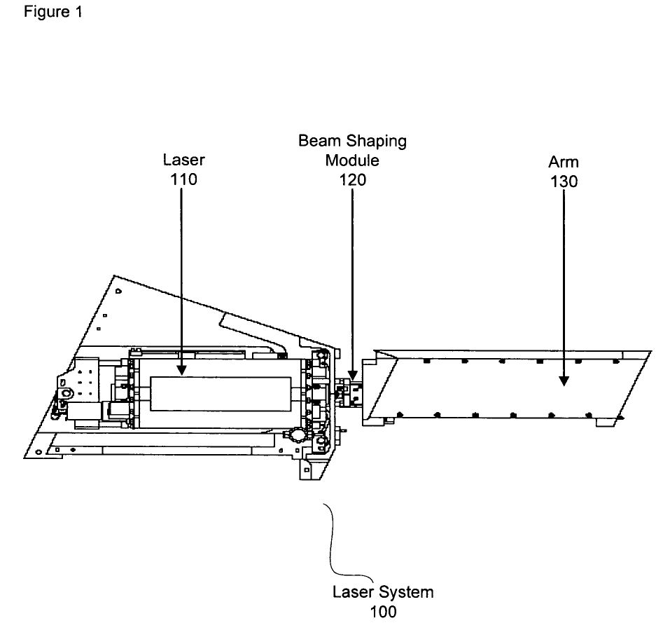

FIG. 1 is a diagrammatic representation of an embodiment of a laser system 100 according to the present invention. Laser system 100 is comprised of laser 110 which generates a laser beam that passes through beam shaping module 120 (BSM 120). BSM 120, according to one embodiment, includes a lens and a diffraction grating. After passing through BSM 120, the laser beam passes through arm 130 (arm 130 refers to additional laser path optics, such as an arm and head assembly) which can be or include a closed volume.

According to one embodiment, laser 110 comprises an excimer laser. An excimer laser is a type of ultraviolet chemical laser which is commonly used in ophthalmic surgery. An excimer laser typically uses as a laser gas a combination of an inert gas (e.g. Neon) and a reactive gas (e.g. Fluorine). Under appropriate electrical stimulation, laser gas in a laser cavity gives rise to laser light in the ultraviolet range. This light can be focused and is capable of very delicate control. Rather than burning or cutting material, an excimer laser disrupts molecular bonds, thus disintegrating tissue in a controlled manner through ablation rather than burning. Thus excimer lasers have the useful property that they can remove fine layers of tissue with almost no heating or change to surrounding tissue. These properties make excimer lasers well suited for delicate surgeries such as ophthalmic surgery.

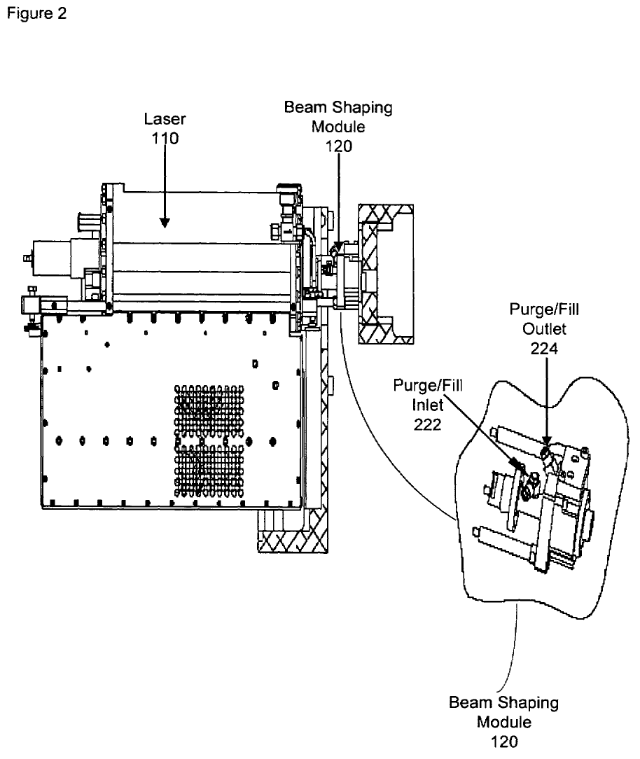

FIG. 2 is a diagrammatic representation of components of an embodiment of laser system 100 of this invention configured to use spent laser gas to prevent Ozone attenuation. Laser 110 is coupled to BSM 120 which is closed off and sealed. Laser 110 generates a laser beam which passes through BSM 120. The laser beam can pass through additional optics (e.g. contained in arm 130 of FIG. 1) and sealed or closed volumes. Filtered laser gas flows into BSM 120 through purge/fill inlet 222. The spent laser gas fills BSM 120, purging BSM 120 by displacing whatever gas, if any, was in the BSM 120. The displaced gas exits BSM 120 through purge/fill outlet 224. Gas flowing out of purge/fill outlet 224 can similarly be used to purge and fill downstream sealed or closed volumes in the laser beam path.

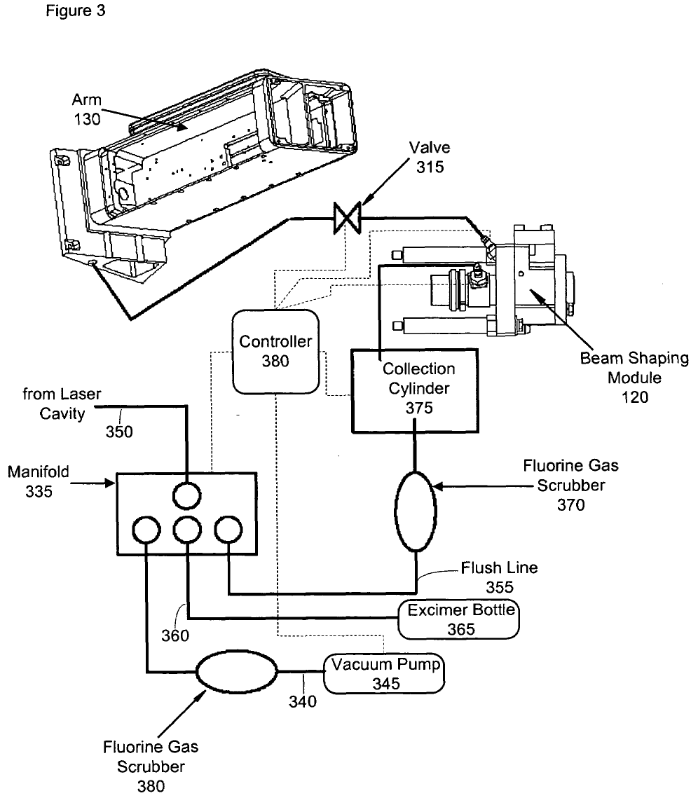

FIG. 3 is a block diagram illustrating one embodiment of a system of this invention for using spent laser gas from an excimer laser to prevent Ozone interference causing laser beam attenuation. In FIG. 3, BSM 120 and arm 130 are shown separately, but it should be understood that they typically remain attached as shown in FIG. 1. A manifold 335 connects various fluid flowpaths together to allow fluid flow. Flow between the flowpaths can be regulated by a system of valves and conduits in manifold 335. According to one embodiment, the valves can be variously configured to connect vacuum flowpath 340, leading to a vacuum pump 345, to flowpath 350 (which leads to the laser cavity) and to flush line flowpath 355, as will be known to those having average skill in the art. Additionally, the valves in manifold 335 can be configured to connect flowpath 360 from excimer bottle 365 (serving as a laser gas supply) to flowpath 350. The system of valves can include an additional valve 315 to control flow between BSM 120 and arm 130. The valves of manifold 335 and valve 315 can be solenoid valves, pneumatic valves or other valves known in the art and can be remotely operated and/or mechanically, electrically or manually actuated.

Flush line flowpath 355 intersects a Fluorine gas scrubber 370 which removes Fluorine gas from laser gas flowing to BSM 120 via collection cylinder 375, which acts as a flow buffer. An additional Fluorine gas scrubber 380 can remove Fluorine from vacuum flowpath 340. These scrubbers can be charcoal scrubbers, scrubbers using Potassium Hydroxide or other scrubber to remove Fluorine from the spent excimer gas as will be familiar to those having skill in the art.

According to one embodiment, a controller 380 can control the operation of various components. Controller 380 can include a processor (e.g. CPU, ASIC or other processor), a computer readable memory and instructions stored on the computer readable memory that are executable by the processor to perform various functions such as generating control signals to vacuum pump 345, the valves of manifold 335 and valve 315. The processor may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The computer readable memory may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processor implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory stores, and the processor executes, operational instructions corresponding to at least some of the steps and/or functions illustrated in the FIGS. Although shown as a single controller in FIG. 3, the functionality of controller 380 can be distributed.

In operation, manifold 335 can be configured to allow gas to flow from excimer bottle 365 to the laser cavity over flowpaths 360 and 350 to fill the laser cavity with excimer gas. When a sufficent amount of gas has entered the laser cavity, manifold 335 can be configured to seal flowpaths 360 and 350. After a predetermined number of operations with the laser, gas from the laser cavity can be directed to BSM 120. According to one embodiment of the present invention, manifold 335 is configured to connect flush line flowpath 355 to vacuum pump flowpath 340. Vacuum pump 345 is operated to create a vacuum or partial vacuum in BSM 120. That is, the pressure in BSM 120 is lowered to below the pressure in the laser cavity. Vacuum pump 345 can be stopped and manifold 335 configured to connect flowpath 350 to flush line flowpath 355, thereby allowing spent excimer gas to flow from the laser cavity to BSM 120. In flowing from the laser cavity to BSM 120, the spent excimer laser gas can pass through Fluorine gas scrubber 370 to remove residual Fluorine. A collection cylinder 375 can function as a buffer volume to slow gas flow into BSM 120. Although collection cylinder 375 is described as a cylinder, any appropriate buffer volume can be used. During this process, valve 315 can remain closed. When a sufficient amount of gas has been directed from the laser cavity into BSM 120, the valve in manifold 335 leading to flush line 355 is closed, trapping the spent excimer gas between the valve in manifold 335 leading to flush line flowpath 355 and valve 315. Thus spent excimer laser gas is sealed in a volume that includes a sealed portion of the optical path (e.g. a portion of BSM 120). In another embodiment, the inlet and outlet ports of BSM 120 can close to seal spent excimer laser gas in BSM 120. The determination of when a sufficient amount of spent excimer laser gas has been directed to BSM 120 can be done based on the pressure at the laser cavity, the pressure at BSM 120 or other measure indicative of the amount of gas and can be an automated process controlled, for example, via controller 380.

In the foregoing example, spent excimer gas is flowed to BSM 120. At the next gas change (i.e. the next time gas in the laser cavity is changed), the spent excimer gas in BSM 120 can be vented or the spent excimer gas can be directed to other volumes in the optical path. For example, at the next gas change, manifold 335 can be configured to connect flowpath 350 to flush line flowpath 355. Additionally, valve 315 can be opened. Thus spent excimer gas can flow from the laser cavity to BSM 120 and gas from BSM 120 can flow into arm 130. When an appropriate amount of gas has left the laser cavity, valve 315 and the valves in manifold 335 can be closed. As an example, when the pressure in the laser cavity drops to 1.5 ATM, indicating that a particular amount of gas has flowed into arm 130 (e.g. 13 liters of spent excimer gas), valve 315 and the valves of manifold 335 can be closed. According to one embodiment, arm 130 is not hermitically sealed (i.e. can leak to atmosphere). Thus, for example, the pressure in arm 130 can be 1 ATM while the pressure in the laser cavity and BSM 120 is 1.5 ATM. The laser cavity can then be vacuumed out and new excimer gas added.

Closed volumes in the laser beam path purged and filled by filtered laser gas need not be hermetically sealed to reap advantages from this invention. Even if a volume is not completely sealed, beam attenuation will be diminished if filtered spent laser gas is used to purge the volume of Ozone and Oxygen. Because Neon is heaver than Oxygen, Neon will fill and settle within a closed volume, hindering Oxygen seepage into the volume, thus hindering the formation of Ozone. Consequently, beam attenuation can be diminished by purging and filling lightly sealed or closed volumes with filtered laser gas.

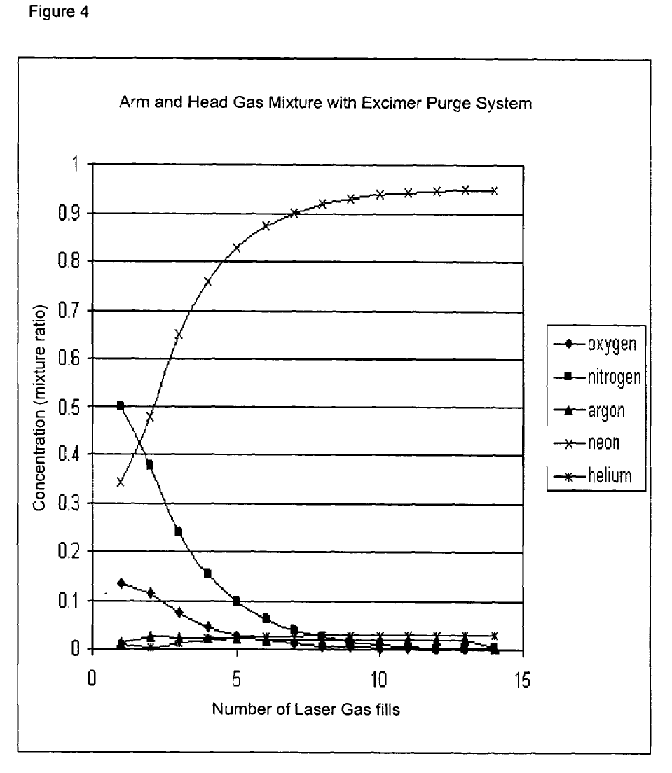

FIG. 4 is a graph of a gas mixture ratio in one embodiment of a system for using spent excimer laser gas to prevent Ozone interference causing laser beam attenuation. The graph of FIG. 4 charts the gas mixture ratio in a closed-but not hermetically sealed-volume in the laser beam path (i.e. the arm and head-shown as arm 130 in FIGS. 1 and 3) over the course of multiple excimer laser gas fills. The X axis represents the number of times spent excimer gas has been changed and the closed volume has been filled with the spent excimer gas. The Y axis represents the concentration of Oxygen, Nitrogen, Argon, Neon and Helium in the closed, but not sealed, volume. As is apparent from the graph, over the course of multiple excimer gas changes, the percentage of Neon in the gas mixture rises, while the percentage of Oxygen falls. As exemplified by the graph, in some embodiments of the present invention, Oxygen can be purged from a closed volume over the course of several laser gas changes, and the changes can occur at different times. Further exemplified by the graph is that there may be an initial laser gas change and fill and that the changed-out laser gas can be used to fill closed volumes in the laser beam path, reducing laser beam attenuation from the onset.

Embodiments of the present invention can be used in a variety of laser systems to improve optical transmission efficiency, and can increase the life of system components and decrease system costs and the size of the apparatus. The present invention uses filtered laser gas to reduce and prevent Ozone from obstructing the optical path of the laser beam. For example, in some embodiments, laser gas will be used to displace Oxygen in the optical path of a laser beam, thus preventing the formation of Ozone.

Thus, embodiments of the present invention can include creating spent excimer gas in a laser cavity and directing the spent excimer gas to a volume at least partially in the optical path of a laser. For example, spent excimer laser gas can be directed to a volume defined by a BSM, a volume between two valves including the BSM, a volume in an arm or other volume that intersects the optical path of the laser. Flow of spent excimer gas from the laser cavity to the various volumes can be controlled by configuring one or more valves, such as the valves of manifold 335 and additional valve 315, to allow fluid flow. A controller can control the valves and other components, such as a vacuum pump.

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by, persons of ordinary skill in the art having reference to this description. It is contemplated that all such changes and additional embodiments are within scope of the invention as claimed below.

What is claimed is:

1. A method comprising:
creating spent excimer laser gas in a laser cavity; and
directing the spent excimer laser gas to a volume at least partially in an optical path of a laser beam.

2. The method of claim 1, wherein the volume is a closed volume.

3. The method of claim 2, wherein the closed volume is hermetically sealed.

4. The method of claim 2, wherein the closed volume is at least partially defined by a beam shaping module.

5. The method of claim 1, wherein directing the spent excimer laser gas to the volume further comprises:
reducing a pressure of the volume to below a pressure of the laser cavity,
configuring one or more valves to allow the spent excimer laser gas to flow from the laser cavity to the volume.

6. The method of claim 5, further comprising sealing the volume to trap the spent excimer laser gas in the volume.

7. The method of claim 1, further comprising directing the spent excimer gas to the volume until the laser cavity reaches a particular pressure.

8. The method of claim 1, wherein the spent excimer laser gas is comprised of an inert gas.

9. The method of claim 8, wherein the inert gas is Neon.

10. The method of claim 9, wherein the percentage of Neon in the spent excimer laser gas is greater than 95%.

11. The method of claim 1 further comprising directing spent excimer laser gas from the volume to a second volume in the optical path of the laser.

12. A laser system comprising:
a laser configured to produce a laser beam, the laser comprising a laser cavity configured to contain a laser gas;
the laser system defining a first volume at least partially in the optical path of the laser beam; and
one or more valves fluidly coupled to the first volume and the laser cavity to selectively couple the laser cavity to the first volume.

13. The system of claim 12, further comprising a controller configured to control the one or more valves to selectively couple the laser cavity to the first volume.

14. The system of claim 13, further comprising a vacuum pump fluidly coupled to the one or more valves.

15. The system of claim 14, said controller configured to control the one or more valves to fluidly couple the vacuum pump to the laser cavity and the first volume.

16. The system of claim 15, wherein when the vacuum pump is fluidly coupled to the laser cavity, it is not fluidly coupled to the first volume.

17. The system of claim 15, wherein when the vacuum pump is fluidly coupled to the first volume, it is not fluidly coupled to the laser cavity.

18. The system of claim 15, further comprising a laser gas supply fluidly coupled to the one or more valves.

19. The system of claim 18, wherein the controller is configured to control the one or more valves to fluidly couple the laser gas supply to the laser cavity.

20. The system of claim 15, wherein the controller is configured to:
control the one or more valves so that the first volume is fluidly coupled to the vacuum pump;
direct the vacuum pump to reduce pressure in the first volume when the vacuum pump is fluidly coupled to the volume;
control the one or more valves so that the first volume is fluidly coupled to the laser cavity; and
control the one or more valves to close the first volume.

21. The system of claim 12, wherein the first volume is at least partially defined by a beam shaping module.

22. The system of claim 13, wherein the laser system defines an additional volume at least partially in the optical path of the laser beam, wherein the one or more valves include at least one valve between the first volume and the additional volume.

23. The system of claim 22, wherein the controller is configured to control the one or more valves to selectively couple the first volume to the additional volume.

24. The system of claim 23, wherein the controller is configured to:
at a laser gas change, control the one or more valves to fluidly couple the laser cavity to the first volume and the first volume to the additional volume to allow the laser gas to flow to the first and the additional volume; and
control the one or more valves to close off the first volume.

25. The system of claim 24, wherein the first volume is hermetically sealed.

26. The system of claim 25, wherein the additional volume is not hermetically sealed.

27. The system of claim 24, wherein the controller is configured to control the one or more valves to close off the first volume when a predefined condition is met.

28. The system of claim 27, wherein the predefined condition is the laser cavity reaching a particular pressure.

29. The system of claim 12, further comprising a scrubber to remove Fluorine from laser gas directed to the first volume.

30. The system of claim 12, further comprising a buffer volume to slow gas flow from the laser cavity to the first volume.

31. A method comprising:
directing laser gas from a laser cavity of a laser system to a first volume at least partially in the optical path of a laser beam produced by the laser system; and
sealing the laser gas in the first volume until a subsequent laser gas change.

32. The method of claim 31, further comprising:
at a subsequent laser gas change, directing laser gas from the first volume to a second volume at least partially in the optical path of the laser beam;
directing laser gas from the laser cavity to the first volume; and
closing off the first volume.

33. The method of claim 31, wherein the laser gas comprises at least 95% Neon.
